(19) United States
(12) Patent Application Publication
(10) Pub. No.: US 2009/0270155 A1
(43) Pub. Date: Oct. 29, 2009

(54) System and method for creating and scoring a prediction game

(76) Inventors: Sean Glass, London (GB); Logan Lindsell, Las Vegas, NV (US); Johannes Larcher, La Canada, CA (US); Patrick Veverka, Virginia Beach, VA (US); Peter Radchenko, Los Angeles, CA (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 12/150,434

(22) Filed: Apr. 28, 2008

(51) Int. Cl. G06F 17/00

(52) U.S. Cl. 463/16; 463/43

(57) ABSTRACT

A method is provided for creating a prediction game. This method includes the steps of selecting an outcome relative to which a prediction may be made; receiving predictions regarding the outcome from a plurality of players; measuring the accuracy of each player's prediction compared with the actual outcome, and computing a score for each player in accordance therewith; and ranking the players in accordance with the respective scores. In an embodiment, the game is a competition among the players, to see who makes the most accurate predictions. The measuring step may also include calculating a value for each player representing a difference between the player's prediction and the actual outcome. The computing step may also include performing a statistical analysis of all the values relating to the outcome.

### FIELD OF THE DISCLOSURE

This disclosure relates to creation and scoring of a prediction game (that is, a game played between two or more people and based on a set of events, where each player predicts the outcome of the events). In particular, the game may be played as a parimutuel wagering game through an online system, for entertainment or (where permitted) with monetary payouts.

### BACKGROUND OF THE DISCLOSURE

Current fantasy sports games and sports betting are limited in several ways. Sports betting generally involves only a single event. If there is a parimutuel style bet, it is not in a form where players are competing in predicting across multiple events with the closest being the winner. In fantasy sports, the game is generally not designed to be flexible. In other forms of prediction games (e.g. the familiar NCAA basketball tournament bracket pool), players are limited to predicting wins and losses in a fixed set of events.

Conventional fantasy or prediction games score players only versus the actual results; a given player's performance versus the other players is not taken into account. This does not create as compelling a game in a case where player gets a difficult prediction right; the player does not get extra benefit for having made a good guess on something that no one else could get right.

It is desirable to facilitate creation, management and scoring of prediction games (especially those played online) in which the accuracy of the prediction may be expressed numerically, players' predictions compared with one another, and the most successful players rewarded accordingly. Furthermore, it is desirable to adapt a prediction game to other categories of events whose future outcome is unknown (e.g. politics, financial markets, weather, etc.).

### SUMMARY OF THE DISCLOSURE

The present disclosure provides a method for creating a prediction game. This method includes the steps of selecting an outcome relative to which a prediction may be made; receiving predictions regarding the outcome from a plurality of players; measuring the accuracy of each player's prediction compared with the actual outcome, computing a score for each player in accordance therewith; and ranking the players in accordance with the respective scores. In an embodiment, computing the score for a player further comprises determining the relative accuracy of all players' predictions, so that the game is a competition among the players, to see who makes the most accurate predictions. The measuring step may also include calculating a value for each player representing a difference between the player's prediction and the actual outcome. The method may further include calculating a distribution of the differences for all players, and using a statistic related to that distribution to calculate the value. The computing step may also include performing a statistical analysis of all the values relating to the outcome. In particular, the computing step includes a procedure for eliminating outliers among the predictions, so that the scores are not accidentally or deliberately skewed.

According to another aspect of the disclosure, a system comprises a computing device configured to construct a prediction game, in accordance with a host (an individual making decisions regarding construction of the game) selecting an outcome relative to which a prediction may be made. The computing device is also configured to receive predictions regarding the outcome from a plurality of players; measure the accuracy of each player's prediction compared with the actual outcome; compute a score for each player in accordance with that measuring; and rank the players in accordance with the respective scores.

According to a further aspect of the disclosure, a computer-readable storage medium has stored therein instructions for performing a method, where method includes the steps outlined above.

According to an additional aspect of the disclosure, a user interface includes a first section for composing a prediction game, including a list of events, a list of outcomes relating to each of the events, a maximum number of points to be awarded based on a prediction of an outcome, an entry fee for each player, and a schedule for making payouts to players. The user interface also includes a second section for viewing the prediction game while under construction.

The foregoing has outlined, rather broadly, the preferred features of the present disclosure so that those skilled in the art may better understand the detailed description of the disclosure that follows. Additional features of the disclosure will be described hereinafter that form the subject of the claims of the disclosure. Those skilled in the art should appreciate that they can readily use the disclosed conception and specific embodiment as a basis for designing or modifying other structures for carrying out the same purposes of the present disclosure and that such other structures do not depart from the spirit and scope of the disclosure in its broadest form.

### BRIEF DESCRIPTION OF THE DRAWINGS

FIG. 1 is a schematic illustration of a hierarchy of content categories that may be the subject of a prediction game.

FIG. 2 schematically illustrates a system for implementing a prediction game in accordance with an embodiment of the disclosure.

FIG. 3 is a flowchart illustrating a process for creating, launching, scoring and making payouts in a prediction game according to an embodiment of the disclosure.

FIG. 4 schematically illustrates a home page for a web site offering a prediction game in accordance with an embodiment of the disclosure.

FIG. 5 is a flowchart illustrating a process which may be used by a game host to create a prediction game with a template, in accordance with an embodiment of the disclosure.

FIG. 6 schematically illustrates a user interface for creating a game from one of a set of templates, in accordance with an embodiment of the disclosure.

FIG. 7 is a flowchart illustrating a process which may be used by a game host to create a prediction game by individually selecting events, parameters and game details, in accordance with an embodiment of the disclosure.

FIG. 8 is a flowchart illustrating further details of the process of FIG. 7, in which the user may place restrictions on who may be allowed to play a game.

FIGS. 9A-9C schematically illustrate pages viewed by a game host in the process of creating a game, including selecting an event, confirming an event and selecting and weighting game parameters, in accordance with an embodiment of the disclosure.

FIGS. 10A-10C schematically illustrate a user interface which may be used by a game host in the process of creating a game, permitting the host to view a presentation page for the game as it is constructed.

FIG. 11 is a flowchart illustrating a process for playing a prediction game according to an embodiment of the disclosure.

FIG. 12 schematically illustrates a graphical presentation of a game as seen by a player, in accordance with an embodiment of the disclosure.

FIG. 13 is a flowchart illustrating a process for scoring a prediction game according to an embodiment of the disclosure.

FIG. 14 illustrates a result of a prediction game where a numerical prediction is made, and the value awarded each player depends on a distribution of the players' predictions.

FIGS. 15-19 are screenshots of a game creation and launch process where a game host selects events, parameters and settings, in accordance with an embodiment of the disclosure.

### DETAILED DESCRIPTION

A prediction game according to the present disclosure (also referred to herein as a Pikum™ game, pronounced “pick 'em”) is played between two or more people. (“Pikum” is a trademark of Pikum! Holdings Limited.) The game is played based on a set of one or more events, with related outcomes that each player is asked to predict. Each event is something that will happen in the future and will have one or more reported outcomes. (For example, a baseball game is a single event, but has many related outcomes—final score, number of hits, number of strikeouts, number of home runs, etc.) An event may also include a plurality of separate occurrences (for example, the World Series is a set of separate games, but “total number of runs scored in the series” could be viewed as a single outcome). Each outcome for which a player is to make a prediction (referred to herein as a game parameter, also referred to herein as a “Pik”) has a weighting assigned to it. The weighting may be applied by assigning a certain number of points to each Pik, or giving each Pik a percentage weighting (out of 100%). In general, there are two types of outcomes:

(1) An outcome can be a true/false or multiple choice occurrence, whereby it is clear whether the player's prediction is correct or not. Examples are “Will John Smith score a goal in the match?” or “Who will be the winner of the race?” or “Which of the following will win the award for Best Actor?”.

(2) The second type of outcome is a numeric result whereby some numerical statistic is generated as the result of the event. Here, a player's prediction could be exactly correct, or there could be a measurable difference between his prediction and the actual outcome. Examples are “What will the total attendance of a game be”, “How many shots on goal will a certain player have?”.

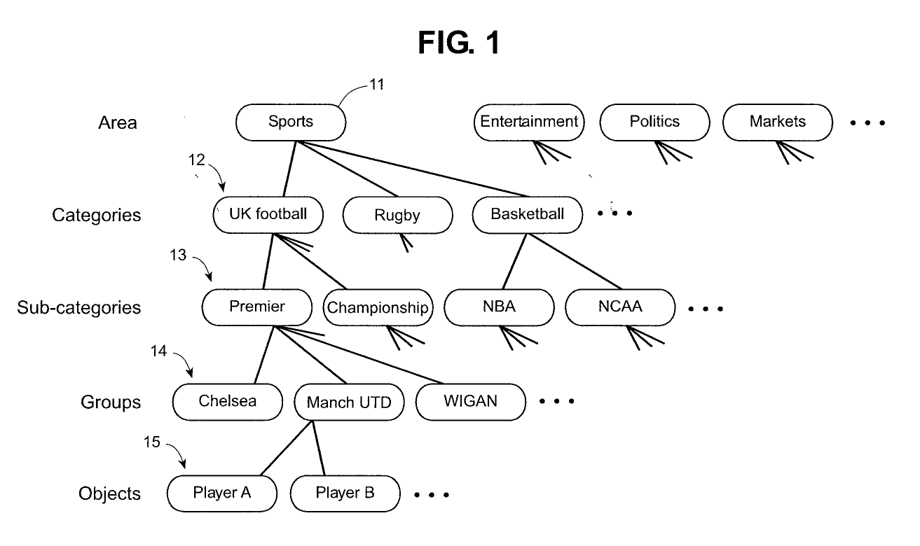

The examples of games presented herein generally relate to sports events. It will be appreciated, however, that a game may involve predictions of any unknown outcome, whether it be sports, entertainment awards shows, politics, stock prices, or even the weather. As shown in FIG. 1, the content of a game in a given area 11 (sports, politics, etc.) may be classified into categories 12, subcategories 13, groups 14, and objects 15. In the area of sports, these terms correspond to sports, leagues, teams, and players. It will be appreciated that the categories of FIG. 1 are illustrations only, and that a prediction game may involve multiple events in different categories.

A person who creates a Pikum game is called the “host.” The host, using a template or a user interface as described in detail below, determines what outcomes (game parameters) players have to predict and how much each parameter is worth in determining the overall winner. A Pikum game could be based on predicting one outcome for one event (e.g. “Number of goals in a football match”), predicting multiple outcomes across multiple events (e.g. “For each game this season, will David Beckham score or not?”), or predicting outcomes from an aggregation of events (“Will David Beckham score more than 20 goals this season?”). The host also sets what the wager is (either in actual money or play currency), and what the payout structure is (e.g. “winner take all,” “top three finishers split the pool 70/20/10”, etc.). The host can also set restrictions on who may play the game—the game may be open to anyone, or possibly open to only the people the host invites.

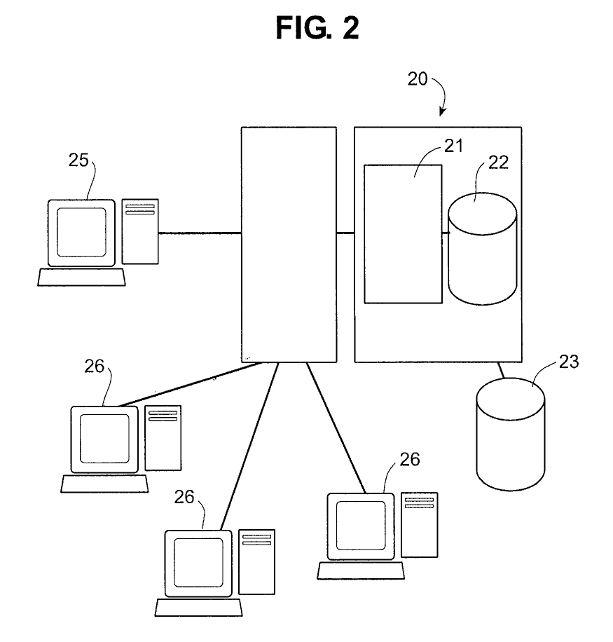

A system 20 for creating and administering a Pikum game, in accordance with an embodiment of the disclosure, is shown schematically in FIG. 2. The system includes a server 21 for performing various tasks, such as: processing input from the host 25; displaying a game to players 26; recording results of events; calculating players' scores; and determining payouts to the players. The system may also include a data storage device 22 for storing game templates, players' profiles, game results, etc. The system 20 may advantageously be in communication with an external device 23 to obtain results of events and other pertinent information. The host and the players may communicate with the system through a user interface 27. Although the host and player devices are depicted as personal computers (PCs) in FIG. 2, it will be appreciated that the host and players may use any of a variety of computing and communication devices to create and play a Pikum game (e.g. a mobile telephone). Furthermore, communication between the system and the host and players may advantageously be carried out over a network (e.g. a LAN, WAN, or the Internet).

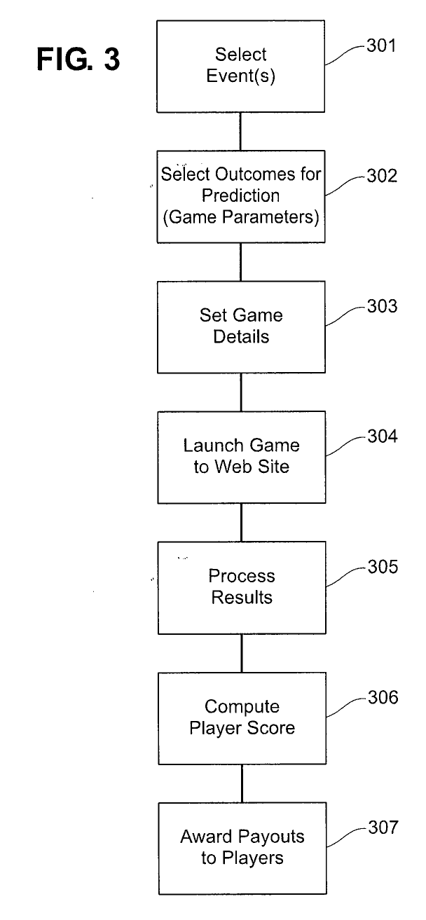

A process embodying the disclosure, in which a host creates and launches a game to be played by a plurality of players, is shown in the flowchart of FIG. 3. The host first selects the event(s) to be included in the game (step 301). In step 302, the host then selects the outcomes which are to be predicted relating to each event (these selected outcomes are also called “Piks” herein). If the event is a football match, for example, then Piks may include the winner of the match, how many goals will be scored by a particular team in the match, or any other unknown outcome. In general, the Piks are based on the results or statistics of an event.

The host also chooses various settings (step 303) to further define the game, described in more detail below. In step 304, the host then launches the game to a website accessible by the players. The results (player inputs and actual outcomes) are processed (step 305), and a score for each player is computed (step 306). Payouts to the players are then awarded (step 307) in accordance with a formula defined by the host; a predefined share of the entry fees (“vigorish”) is generally retained by the system provider.

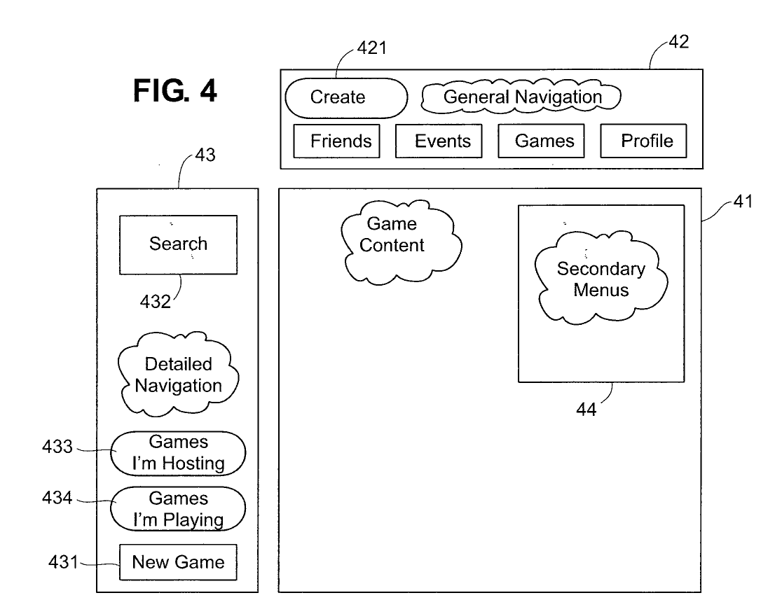

In an embodiment, a home page for the Pikum game website may appear as shown schematically in FIG. 4. The game content is displayed in area 41, while the header 42 has buttons therein for general navigation to other parts of the site. The header may also have a “Create” tab 421 for creating a new game. The navigation bar 43, for detailed navigation within the site, may also have a “New Game” button 431. Navigation bar 43 also includes a “Search” button 432 for finding other games already created, a “Games I'm Hosting” link 433 for navigating to games created by an individual host, and a “Games I'm Playing” link 434 with a list of games a player has entered. An additional menu or menus 44, providing further choices and context in the construction or playing of the Pikum game, may be located inside area 41.

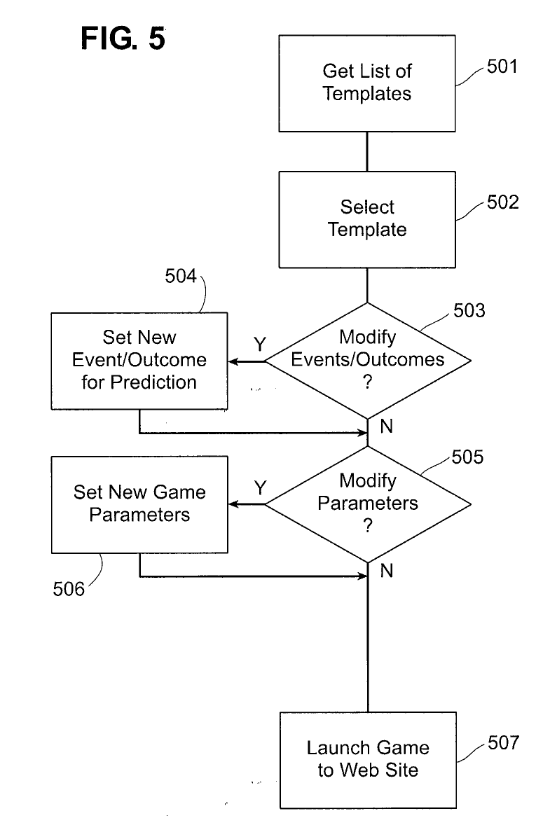

In an embodiment, steps 301-303 of creating a game may be performed by using (and possibly modifying) a template. A process for creating a game using a template is shown in the flowchart of FIG. 5. The host accesses a list of templates (step 501) which may be stored on storage device 22. The host selects a template (step 502) in accordance with a desired event; the event, and the associated outcome to be predicted, may be modified if desired (steps 503, 504). Additional game parameters, predetermined as part of the template, may also be modified if desired (steps 505, 506). The new game is then launched to the web site (step 507) where it may be accessed by other players.

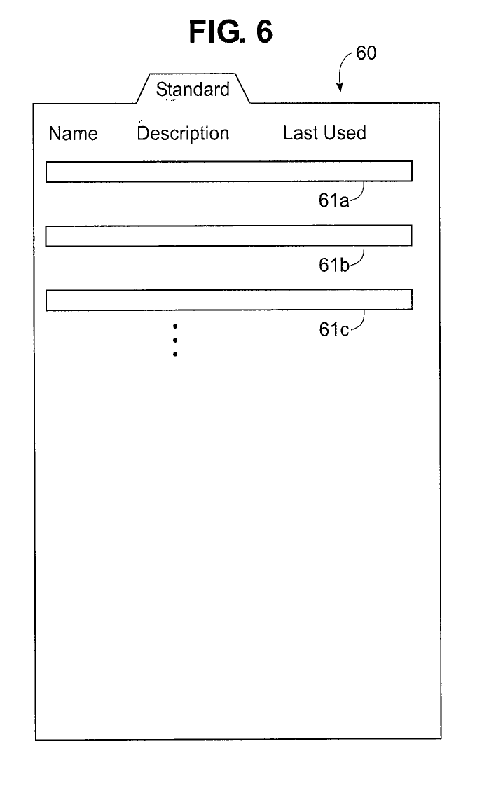

FIG. 6 schematically illustrates a user interface 60 for selecting a template to create a Pikum game. User interface 60 appears on a page of the game website; available templates 61a, 61b, 61c, . . . are listed with their names, brief descriptions and the date the template was last used. Moving a cursor over an entry (e.g. the first entry 61a) causes a preview of the Pikum game to be displayed.

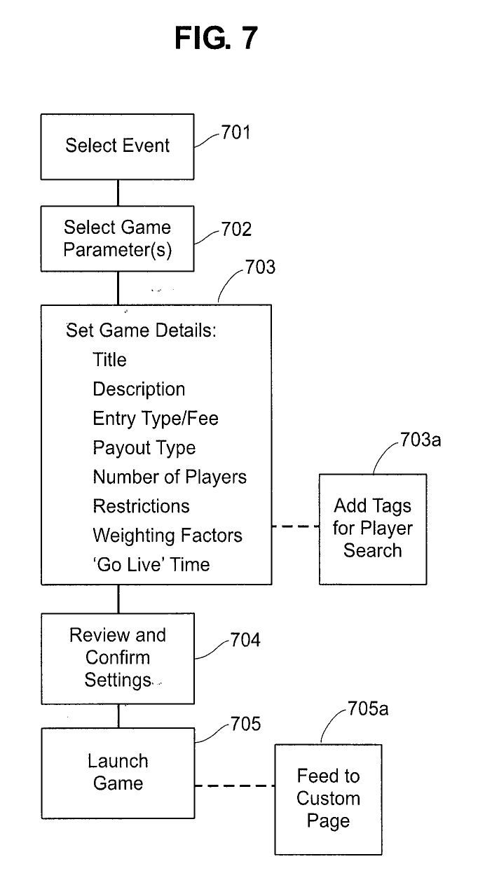

Alternatively, the host may select the event and other parameters of the game without using a template, following a game creation process shown in the flowchart of FIG. 7. The host first (step 701) selects one or more events regarding which players must make specific predictions. (Example: The Manchester United vs. Everton game on Oct. 10, 2007, is selected as an event that will have parameters that will be part of the Pikum game.) The host can select one event or multiple events, or choose a preassembled “event pack” offered by the system. Events from different categories or sports can also be combined into one Pikum game. The host then (step 702) selects the specific parameters that players must choose from for each event or set of events. (Example: The number of goals scored by Manchester United in the Manchester United vs. Everton game on Oct. 10, 2007, is selected as a parameter.) The host can select one or more parameters for each event; parameters can pertain to the event itself (example: game winner), a result relating to a team (example: shots on goal by the home team), or to an athlete (example: Will David Beckham score?). In an embodiment, the host may simply specify a predetermined bundle of parameters (called a “Pik pack”) relating to the event, e.g. for a baseball game the line score (runs, hits, errors) for each team.

In step 703, the host sets the details for the Pikum game, including:

Pikum game title

Pikum game description

A picture associated with the Pikum game

Entry type (actual money, e.g. US dollars, or play money)

Entry fee: in this embodiment, US Dollars are limited to multiples of US$5.00.

Payout type: in this embodiment, several Payout type selections are available, including:
(1) Winner Take All (1^{st} place gets 100%)
(2) Top 3 Players (1^{st} place gets 70%, 2^{nd} place gets 20%, and 3^{rd} place gets 10%)
(3) Top 5 Players (1^{st} place gets 50%, 2^{nd} place gets 25%, 3^{rd} place gets 15%, 4^{th} place gets 7.5%, and 5^{th} place gets 2.5%)

Minimum number of players before the Pikum game goes live. This is a detail that is set so that if less than the minimum number of players enters the game, then the game does not go live, and all players who entered will have their entry fees returned.

Maximum number of players. This is a detail that is set if the host wishes to limit the maximum number of players. The host is also allowed to set this parameter to “unlimited,” which means that there is no restriction on the number of players.

Multiple Entries: The host can choose whether or not players will be allowed to enter the same Pikum game multiple times. For example, a player may enter the same game two times with different Piks each time. In an embodiment, the maximum number of entries per player that the system will allow is five.

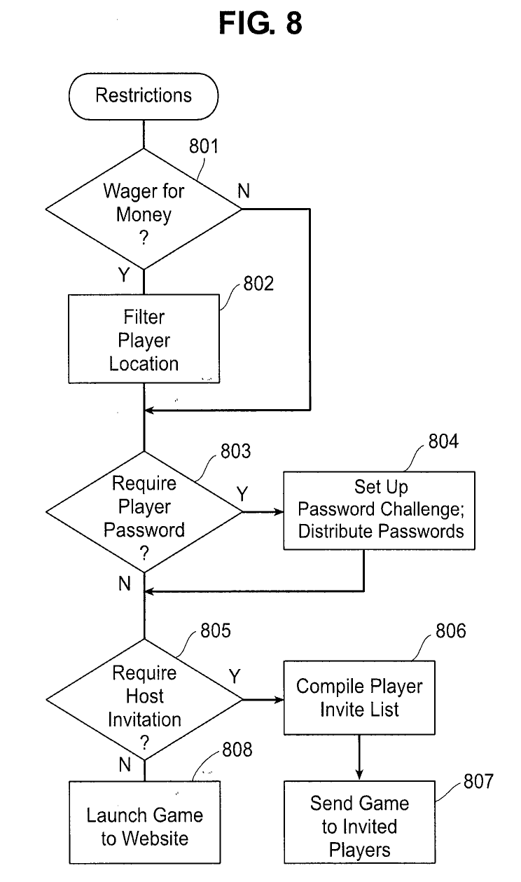

Restrictions on who is permitted to play: in an embodiment, details of a procedure for restricting players is discussed below with reference to FIG. 8.

Weighting factors: how much each parameter is worth in determining the order of finish for players in the Pikum game. By default, each parameter is given equal weight. Thus, if a host has a Pikum game that asks players to choose how many goals Manchester United will score in each of the next four matches, then each parameter (i.e., number of goals scored in each of those matches) will by default be worth 25% when it comes to scoring (see the scoring algorithm section for more details). In this embodiment, the host may choose to change the weighting of each parameter (provided the sum of all parameter weights equals 100) so that one parameter may be worth more than the others in determining the final outcome. For instance, a host could determine that choosing how many goals Manchester United will score in the first match is worth 70% in determining the winner of the Pikum game while choosing how many goals Manchester United scores in each of the other three matches is only worth 10% each. In this situation, a player who does well on the first match, even if that player does poorly on the other three matches, could still win the Pikum game.

The host may also create “tags” (step 703a) which are keywords which help other users find the particular Pikum game. For example, if a host creates a Pikum game about Manchester United, then the host might add tags such as “football,” “Manchester,” “Man U,” etc.

After the host has made all of his selections (or left the defaults in place), the host is taken to a review page which shows everything selected for the Pikum game (step 704). If the host is satisfied with the selections, the host then clicks on a “launch” button (step 705) that causes the Pikum game to become part of the system; other players can then enter the game. In this embodiment, after a game is launched the settings cannot be edited by the host. Alternatively, the host may be permitted to modify settings until the first entry is received.

In a further embodiment, a host (game creator) has the ability to create custom home pages (similar to Ebay stores) where the game may be located (step 705a). A host may create an unlimited number of these pages and integrate their games into them using widgets or feeds.

Certain jurisdictions prohibit online wagering with actual money. Accordingly, it may be necessary to restrict access to a game, depending on a player's location. A procedure for restricting player access is shown in the flowchart of FIG. 8. If the game involves wagering for money, e.g. a U.S. Dollar game (step 801), then the system automatically invokes a filter for the player's location (step 802). The host may also decide whether the game will only be open to players that have a password, or only to players who are directly invited by the host to play. If a password is to be required (step 803), the host then creates and distributes passwords to prospective players (step 804) and sets up a password challenge/verification scheme. If the game is to be by invitation only (step 805), the host then compiles a list of players to be invited (step 806) and sends the game only to those players (step 807). Otherwise, the game is launched (step 808) in the same manner as described above.

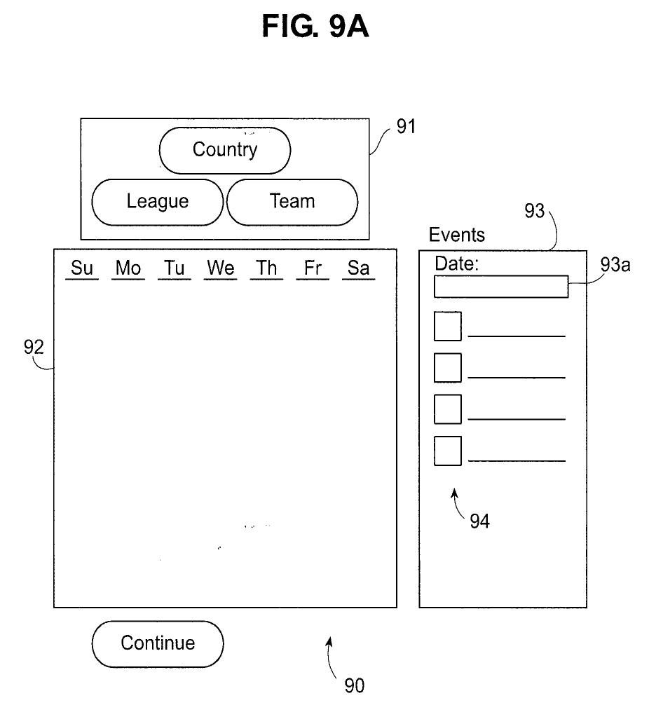

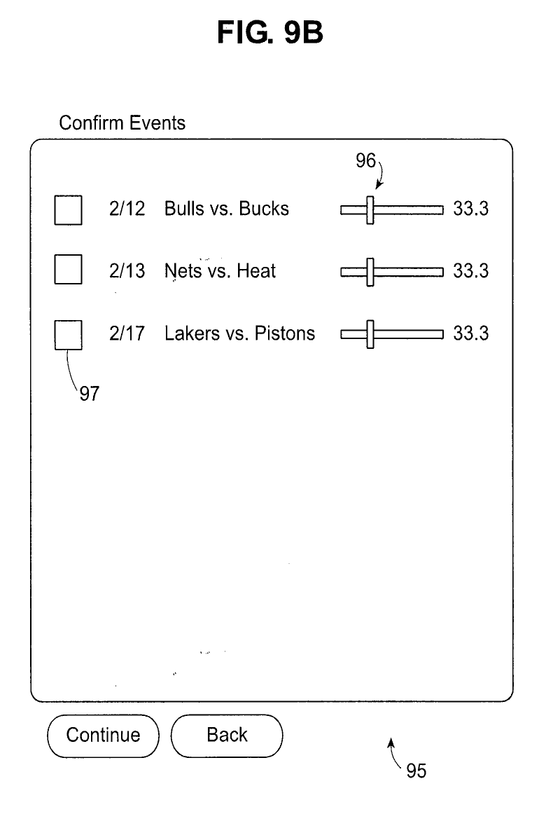

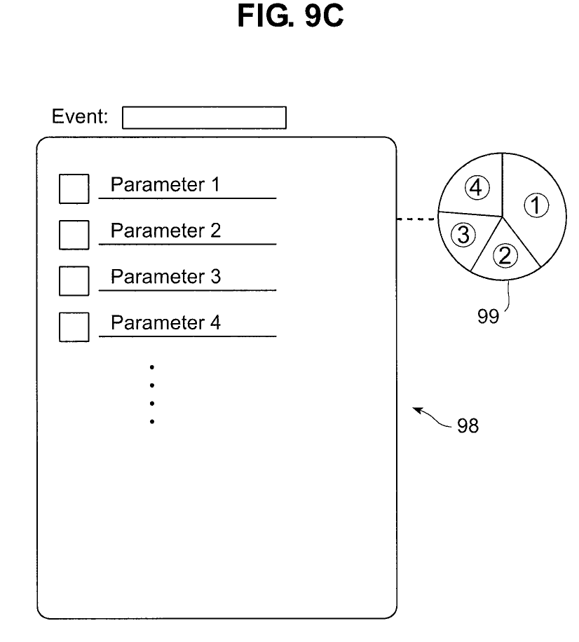

Examples of screens presented to the host while creating a game are shown schematically in FIGS. 9A-9C. An event selection screen 90 (FIG. 9A) includes an event filter 91 that permits the host to narrow down his choices of country, sports league and team. A calendar 92 is divided into date cells; clicking on a specific date causes a list of events for that date to be displayed in the events block 93. The host may also manually enter a date at 93a to retrieve a list of possible events. The host may then click on one or more of the checkboxes 94 to select particular event(s). An event confirmation screen 95 (FIG. 9B) lists the selected events; each event has a “slider” 96 associated therewith, so that the host may select the relative importance of each event in the game. In the example shown, three events have been selected (occurring on different dates), with all set to have equal importance. If the host then clicks one of the checkboxes 97, a parameter selection screen 98 will be displayed, displaying the name of the event and permitting the host to specify the parameters for which the players should make predictions (example: event=Lakers vs. Pistons; parameter1=Lakers points; parameter2=Pistons points; parameter3=Lakers team fouls; parameter4=Pistons team rebounds). The host may then adjust the relative importance of the parameters by modifying the pie chart 99. The default setting is for all parameters to have equal weight; in the example shown, parameter1 has a relative weight of 40% while the other three parameters each have a weight of 20%.

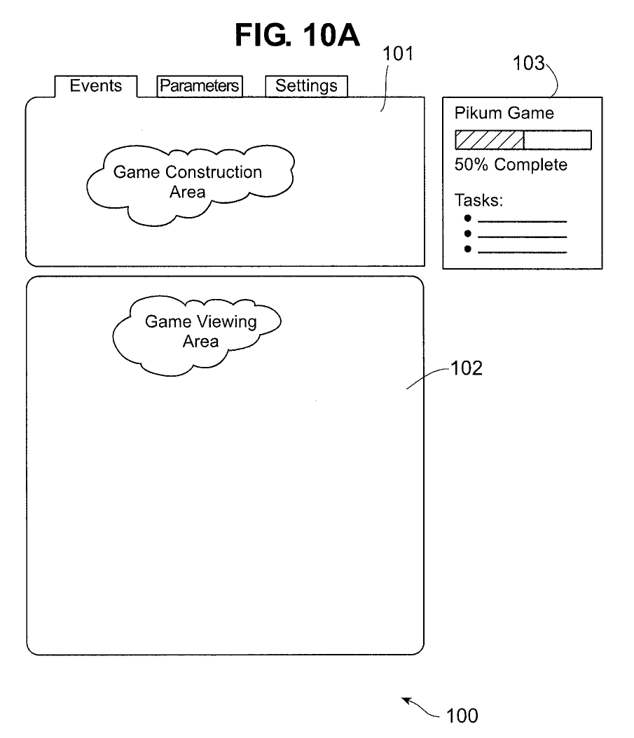

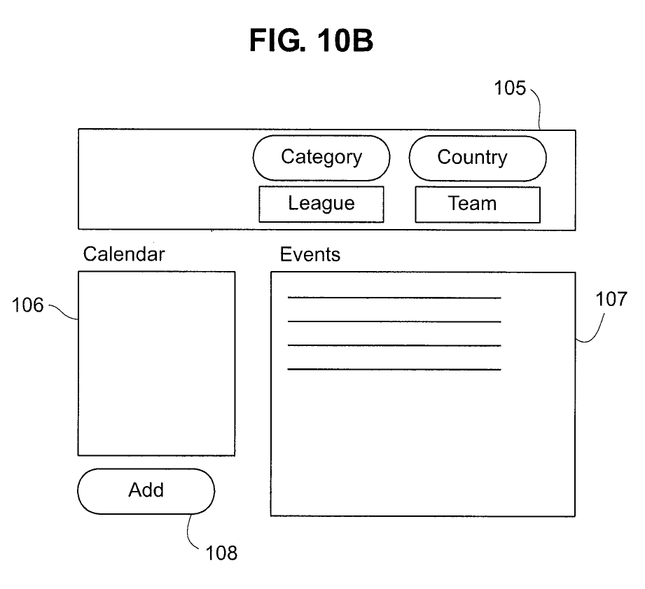

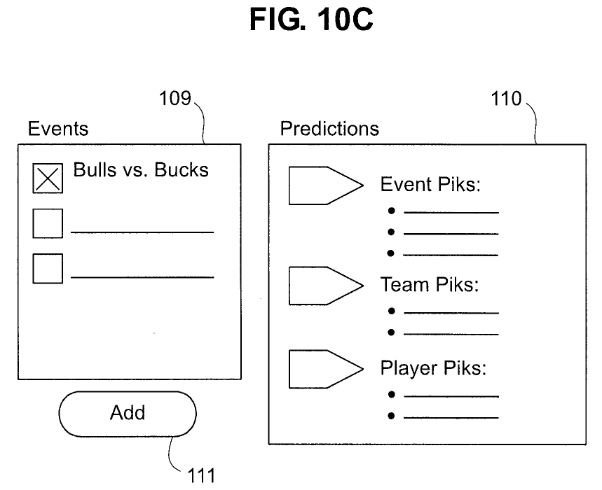

In another embodiment, the host is presented with a screen including a user interface serving as a “construction area” for the game being created, and a “viewing area,” as shown in FIG. 10A. As the host completes the various tasks involved in creating a game (by entering data, checking boxes, etc. in construction area 101), the appearance of the game is represented in the viewing area 102. The host is therefore able to monitor the appearance of the game while it is being created. The system provides a task monitor 103 to remind the host of details that still remain to be resolved before the game may be launched. When the game construction area has the “Events” tab selected, the construction area may appear as in FIG. 10B. An event filter 105 permits the host to narrow down his choices of category (e.g. which sport), country, league and team. A calendar 106 in the construction area may be divided into date cells; clicking on a date causes events for that date to appear in the event list area 107. The host may then select one or more of the listed events, and add it to the game by clicking on the “Add” button 108. When the game construction area has the “Parameters” (or “Piks”) tab selected, the construction area may appear as in FIG. 10C. The selected event(s) are listed in the event list area 109 (if the host has navigated to this construction area without selecting an event, he is prompted to select an event before proceeding). A “Piks tool,” using the type of selected event as an input, displays possible Piks (outcomes to be predicted) in list area 110. As the host selects an event, the tool dynamically offers the types of predictions available to add to the game. The host then selects one or more of those possibilities and adds it to the game parameters by clicking on the “Add” button 111.

After a Pikum game has been launched, changes in its status, scoring, and prize payouts are all controlled by the same automated process. After the game is launched, and until scoring of the game is complete, the game progresses through three states called ActiveBeforeStart, ActiveBeforeLastEventStart and ClosedNotScored, as explained below.

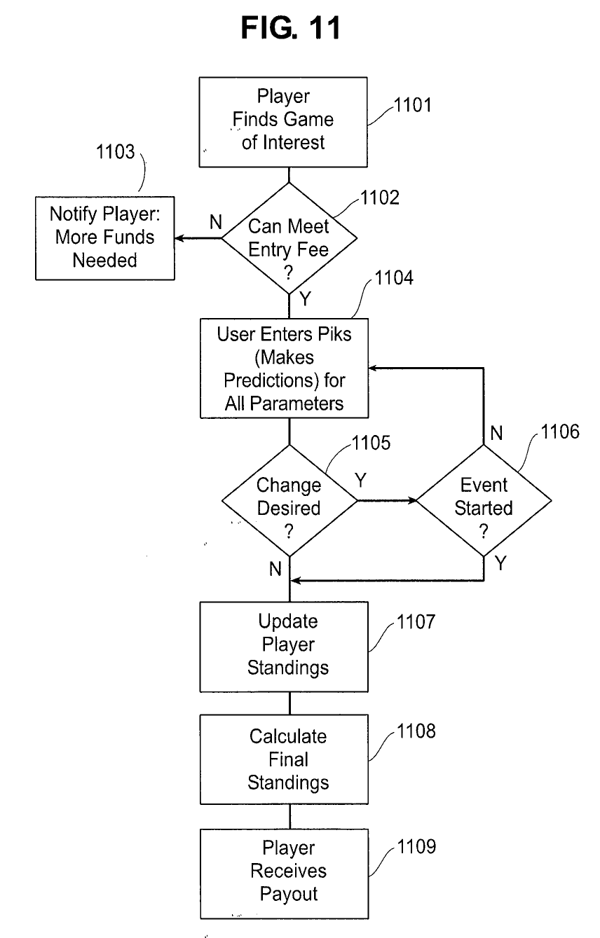

A process of playing a Pikum game, from a player's point of view, is shown in the flowchart of FIG. 11. In step 1101, the player finds a Pikum game that he or she is interested in entering. (The player may find the game by visiting a web site, or may be provided with a link to the game from another source, for example through an online social network.) The system determines (step 1102) whether the player has enough currency (play money, also referred to herein as “Pikles,” or actual money, e.g. U.S. dollars) for the required entry fee; this fee depends on the minimum bid requirement for that particular game. If the player does not have enough Pikles or dollars, then the player is notified accordingly (step 1103).

A player able to meet the entry fee is taken to a page where the player can enter predictions (Piks) for each parameter in the Pikum game. The player makes all of the predictions required by the game, and saves his predictions (step 1104).

A game can only be entered before the time that the first event in the game starts. All Pikum games start in the status ActiveBeforeStart. While the game is in this status new entries are allowed. The automated process checks continually for games reaching their start time, which is set to the start time of the first event in the game. As soon as a Pikum game reaches its start time its status changes to ActiveBeforeLastEventStart and no more entries are allowed. However, if the number of entries at the start time is less than minimum number of entries set by the host on the settings page, the game is cancelled and all players are refunded their full entry stakes. The automated process continues checking the start times of each event in the Pikum game until the start time of the last event in a game is reached. At that time the Pikum game status is changed to ClosedNotScored. If a Pikum game contains only one event, or all the events start at the same time, the game status will go directly from ActiveBeforeStart to ClosedNotScored. The game will remain in the ClosedNotScored state until the event results for each Pik in the Pikum game have been entered automatically or manually.

Piks in a Pikum game can be changed until the time that the event they are related to starts. Once a player has entered a game, the player can change predictions before an event has begun (steps 1105, 1106) but cannot withdraw from the game.

As the events in the Pikum game occur, the system updates the current player standings in the game (step 1107). Once all of the events in the Pikum game have occurred, the system calculates the final standings (step 1108) and payouts are made based on these final standings (step 1109). There will be a short time period between when the results are announced and when payouts are paid so players will have an opportunity to challenge the results if they think there has been a mistake.

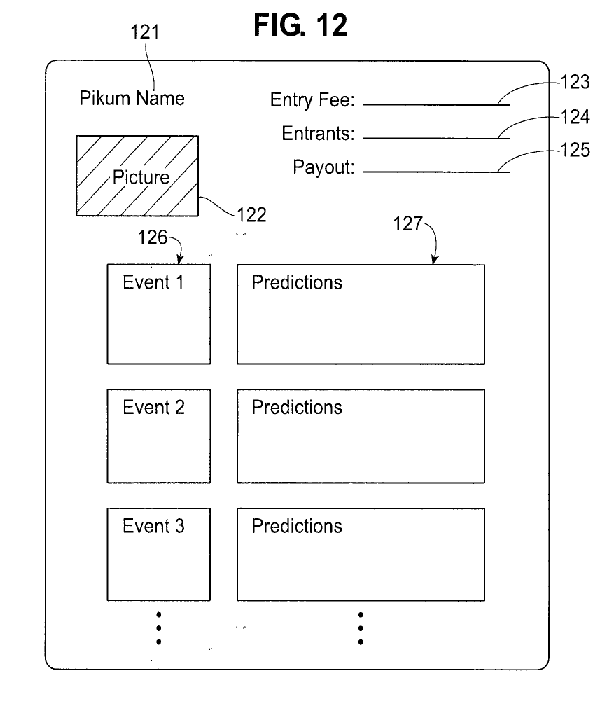

A graphical representation of a Pikum game according to an embodiment, as seen by a player, is shown schematically in FIG. 12. The game is identified by a name 121, and possibly a picture 122, selected by the host. The entry fee 123, entrants' names 124 and payout amount 125 are listed at the top of the screen. The various events 126 involved in the game are listed alongside spaces 127 for the player to enter his predictions (Piks) regarding those events. The predictions may be made by selecting a radio button, entering a numeric value, or selecting from a dropdown menu, depending on the nature of the prediction required.

After the events have concluded, results of the events must be entered into the system 20 so that player scores and payouts may be calculated. In an embodiment, this may be done by keying information directly into server 21. In another embodiment, this may be done using automated data feeds, e.g. official statistics from a sports league transmitted directly to the system over a secure communication link using Secure File Transfer Protocol (SFTP).

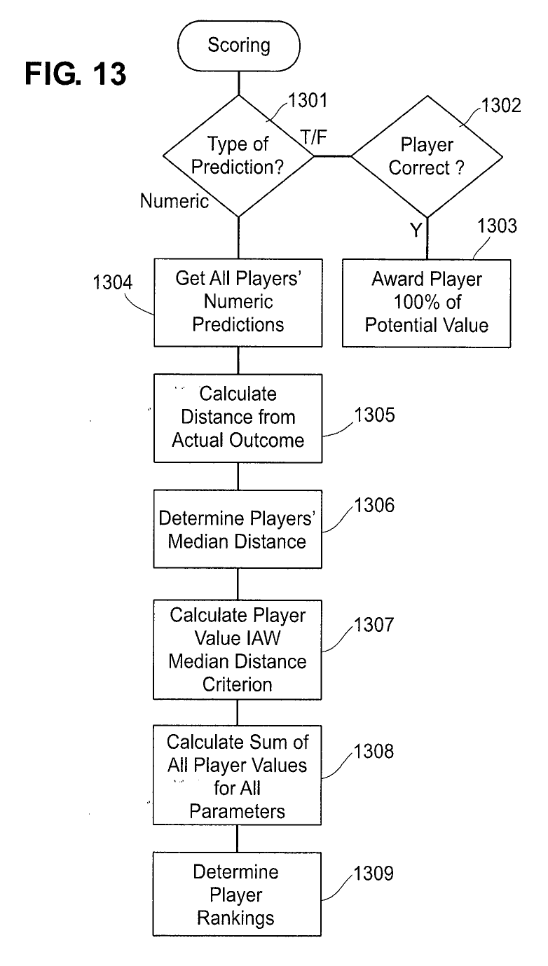

A process for scoring a Pikum game, in accordance with an embodiment of the disclosure, is shown in the flowchart of FIG. 13. There are two types of predictions in Pikum games: (1) True/False (example: “Will David Beckham score?”) and (2) numeric (example: “How many goals will David Beckham score?”). A player receives a certain amount of credit for each parameter based on whether the player picks correctly (if it is a True/False type prediction), or how far away the player's prediction is compared to other players' predictions (if it is a numeric type prediction). Each parameter in a game has a weight which represents its importance in determining the overall winner or winners.

If the prediction is of the True/False type and the player is correct (steps 1301, 1302)—that is, for example, if a player predicts that David Beckham will score and he does score—then (step 1303) the player receives 100% of the potential value of that Pik.

If the prediction is of the numeric type, then the player's score may depend not only on the accuracy of his prediction, but also on all the other players' predictions in relation to his own (steps 1301, 1304). For example, if a player predicts that Beckham will score 3 goals and he only scores 2 goals, then that player will receive less than 100% of the potential value of that Pik, and the amount the player receives will depend on how much better the player's Piks were compared to other players' Piks. This determination may be made using the following procedure:

The system examines each player's Pik and calculates how far it is from the outcome (step 1305); this may be referred to as the “distance,” expressed as an absolute value, between the player's prediction and the actual outcome. The system then determines the median distance amongst all the players (step 1306). Players who have a Pik that results in a distance equal to or greater than 2.5 times this median receive 0% of the value for the Pik. All other players receive a value (step 1307) based on the following formula:

Value=(−1/(2.5*(median distance)))*player Pik distance+1

All players with predictions meeting a predetermined criterion (in this example, within a bound of 2.5 times the median distance) receive a portion of the points available for that Pik based linearly upon where they fall within the bound. A player answering the Pik exactly correct will always receive the full amount of available points.

More generally, a distance from the actual outcome is calculated for each player prediction, and a distribution of those distances is used to define statistics for scoring the game. In the example just above, a linear distribution is used, and the median distance is used as a statistic to determine a criterion for awarding points to a player. Other statistical methods could be used to create a distribution of distances and to award between 0% and 100% of the available points in accordance with the accuracy of a player's predictions.

It will be appreciated that the scoring procedure discussed above is both proximity-based (that is, it depends upon the distance between the predicted outcome and the actual outcome) and peer-based (that is, it depends on the relative accuracy of all the players' predictions for that outcome). The use of a criterion for a maximum distance (e.g. 2.5 times the median distance as discussed above) serves to exclude outlier predictions that could (accidentally or deliberately) skew the scoring.

After each individual Pik has been scored, the Pik scores are for each player are summed together and the result is the player's total score (step 1308). Players are then ranked and assigned finishing places based on their total score (step 1309); this determines preliminary results.

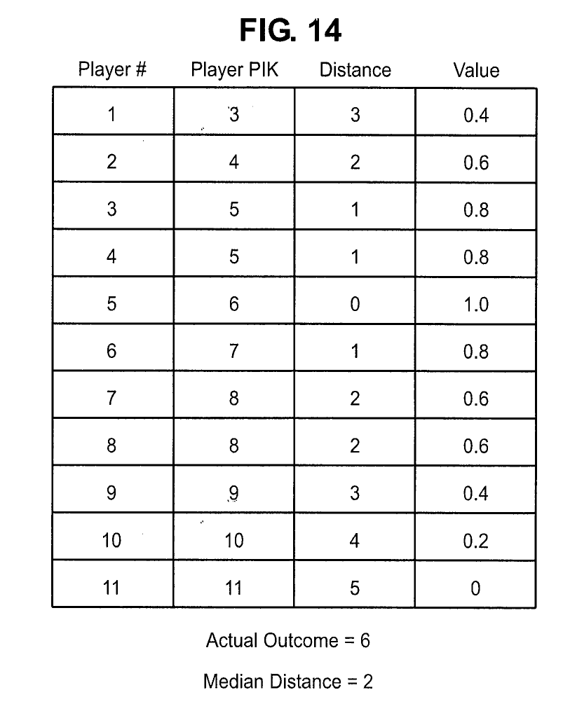

FIG. 14 shows an example of a game where eleven players predicted an outcome; the predictions ranged from 3 to 11, with one player predicting 6, and the actual outcome was 6. The distances therefore range from 0 to 5, with the median distance being 2. Application of the above formula yields a value for each player as shown; player #5, who made a perfect prediction, receives a value of 1.0, while player #11, whose prediction has a distance 2.5 times the median, receives a value of 0.

Once scoring is complete, the Pikum game status changes to ClosedScored and the preliminary results and the preliminary prizes are displayed. The preliminary prizes are awarded to players based on the payout schedule selected by the host. In an embodiment, the system allows for possible errors in the transmission of event results, or the scoring procedure. The game will remain in the ClosedScored state for a period of time (e.g. 24 hours). During that period if any player in the game finds an error with a result that was entered, the scoring calculations, or the preliminary prize calculations, they may dispute the results using a Dispute Results function. If the function is used, the status of the game is changed to ClosedDisputed and will remain in that state until it has been reviewed by an administrator.

In real-money Pikum games, the entry fees are distributed amongst the players with a share optionally being retained by the system provider. The portion of the entry fees that the provider receives may depend on the amount of the entry fee and the number of players who are entered into the game.

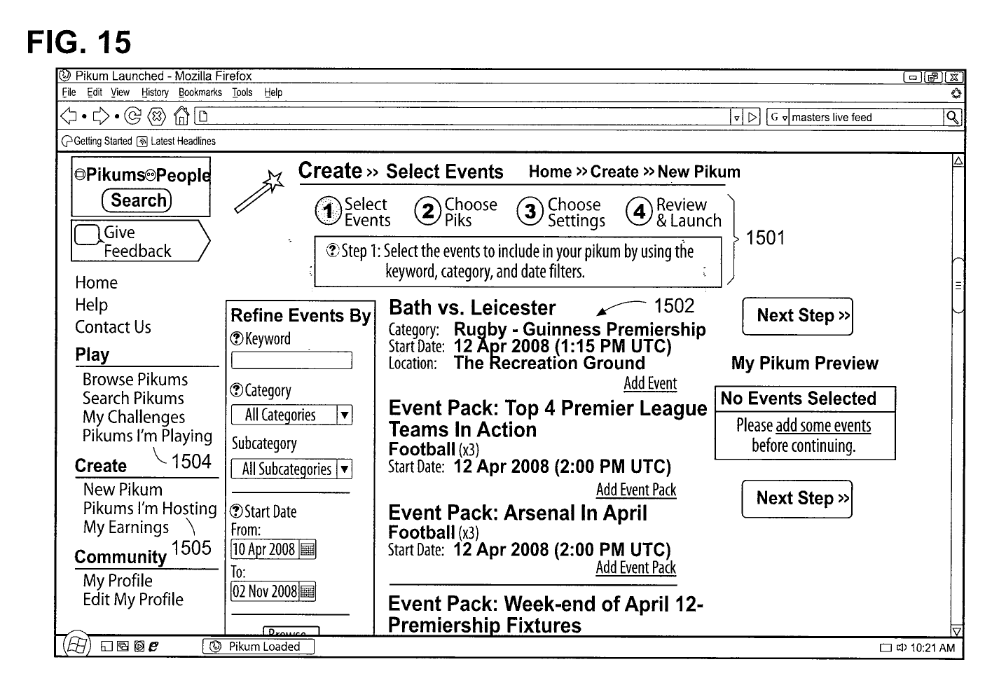

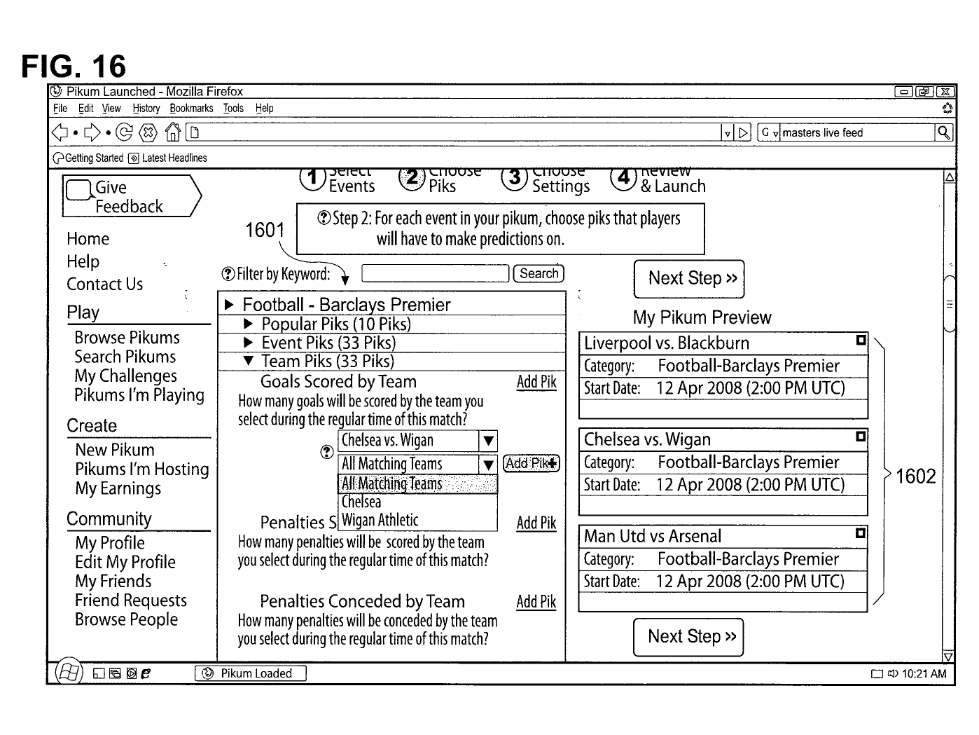

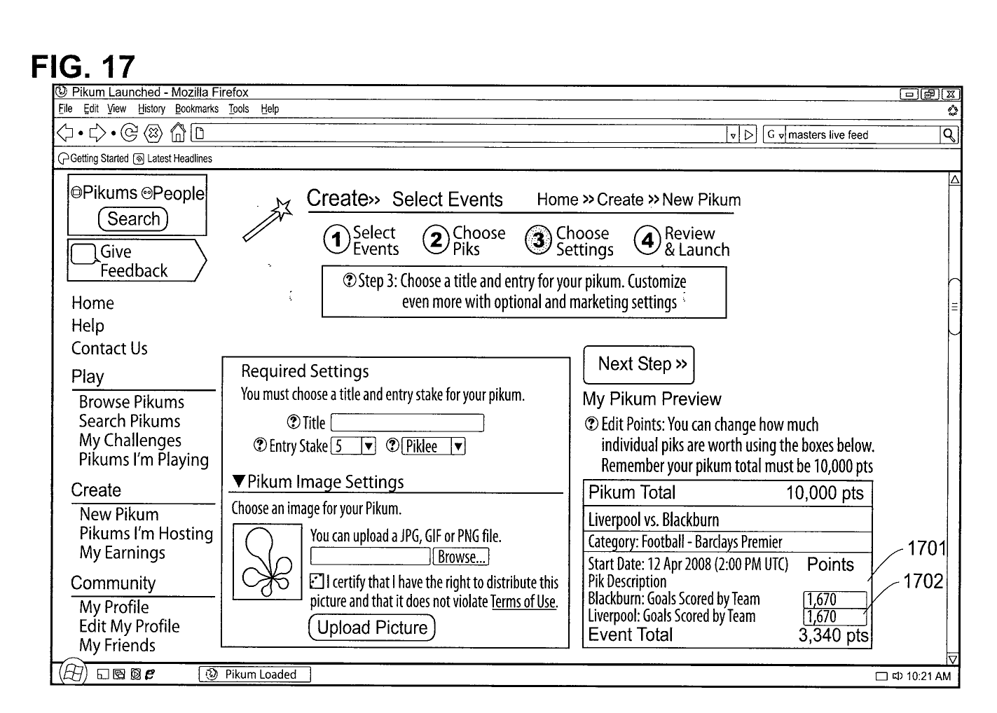

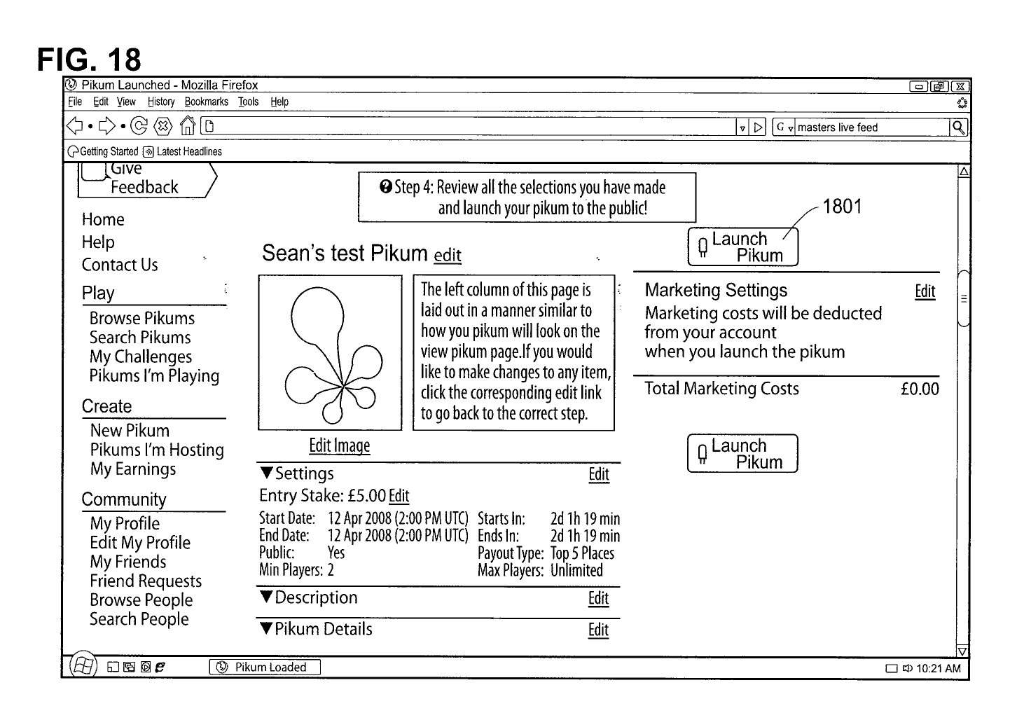

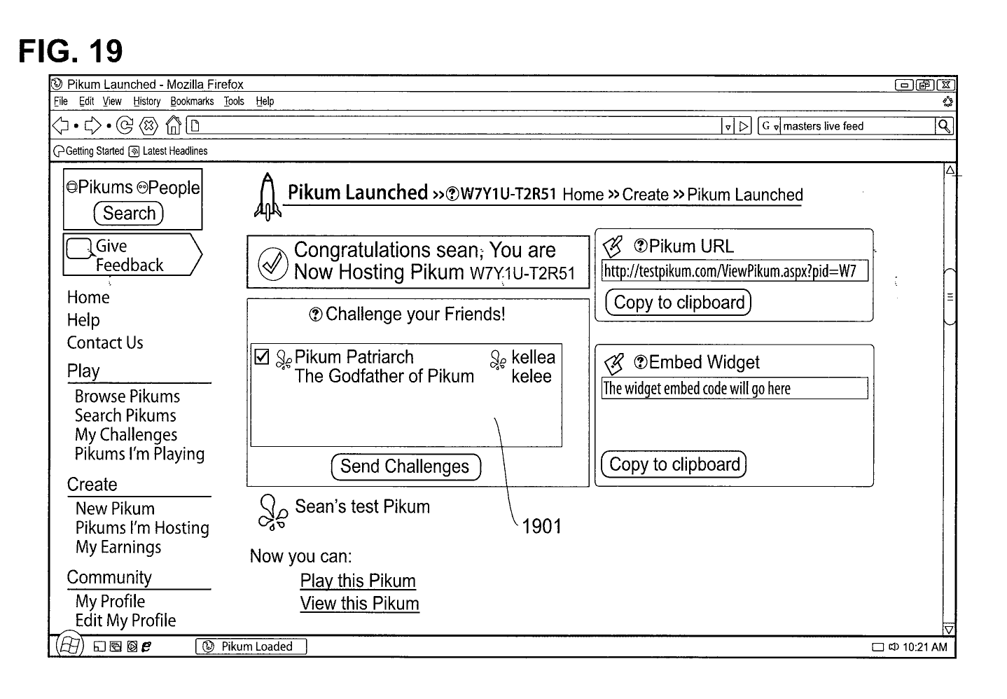

Screenshots showing stages of construction of an actual Pikum game, according to a specific embodiment, appear in FIGS. 15-19. The game construction process is divided into four steps: a central area 1501 of the screen highlights which of the steps the game host is presently working on. FIG. 15 shows a list 1502 of events that may be included in the game, and a section 1503 for narrowing the selection of events. The display also has links 1504, 1505 to other games currently being played or hosted. FIG. 16 shows a menu 1601 of possible predictions (Piks) which might be made regarding the selected events; the selected events are displayed in a list 1602 under “My Pikum Preview.” After the host selects the events and predictions for the game, the host chooses (FIG. 17) a name, entry stake and image to be displayed when the game is launched. At this stage the host also chooses the wager amount, the payout structure, and the maximum number of points 1701, 1702 awarded for each prediction. At the last stage (FIG. 18) the host reviews all of the settings for the game, and then launches the game by clicking the launch button 1801. Another screen (FIG. 19) is then displayed, including a section 1901 listing persons in the host's social network. The host then has the option to inform others about the game through social networks, email or blogs.

It will be appreciated that a very large number of personalized prediction games, covering a wide range of topics and with a flexible number of events, may be constructed in accordance with embodiments of this disclosure.

While the disclosure has been described in terms of specific embodiments, it is evident in view of the foregoing description that numerous alternatives, modifications and variations will be apparent to those skilled in the art. Accordingly, the disclosure is intended to encompass all such alternatives, modifications and variations which fall within the scope and spirit of the disclosure and the following claims.

We claim:

1. A method comprising:
selecting an outcome relative to which a prediction may be made;
receiving predictions regarding said outcome from a plurality of players;
measuring the accuracy of each player's prediction compared with the actual outcome;
computing a score for each player in accordance with said measuring; and
ranking the players in accordance with the respective scores.

2. A method according to claim 1, wherein
said measuring comprises calculating a value for each player according to a difference between the player's prediction and the actual outcome, and
said computing comprises performing a statistical analysis of all said values relating to the outcome.

3. A method according to claim 2, wherein computing the score for a player further comprises determining the relative accuracy of all players' predictions.

4. A method according to claim 2, further comprising calculating a distribution of said differences for all players.

5. A method according to claim 4, further comprising using a statistic related to said distribution to calculate said value.

6. A method according to claim 1, wherein the score for each player is based on predictions of a plurality of outcomes relating to one event.

7. A method according to claim 1, wherein the score for each player is based on predictions of outcomes relating to a plurality of events.

8. A method according to claim 2, further comprising:
computing a maximum value based on a statistic relating to all said values; and
assigning a score of zero to a player for a prediction for which said value exceeds said maximum value.

9. A method according to claim 2, wherein the statistical analysis is performed on a distribution of all said values.

10. A method according to claim 2, wherein the statistical analysis includes computing a median of the values.

11. A method according to claim 1, wherein a plurality of outcomes are selected, and further comprising specifying a relative importance of predictions for each of said outcomes.

12. A method according to claim 1, further comprising:
receiving an entry fee from each player;
awarding payouts to the players in accordance with said ranking.

13. A method according to claim 12, further comprising retaining a portion of the entry fees prior to awarding the payouts.

14. A method according to claim 13, wherein the portion retained varies according to the entry fee for each player and the total number of players.

15. A method according to claim 1, further comprising restricting participation by a player in accordance with a jurisdiction where that player is located.

16. A system comprising:
a computing device configured to
construct a prediction game in accordance with a host selecting an outcome relative to which a prediction may be made;
receive predictions regarding said outcome from a plurality of players;
measure the accuracy of each player's prediction compared with the actual outcome;
compute a score for each player in accordance with said measuring; and
rank the players in accordance with the respective scores.

17. A system according to claim 16, wherein
said computing device is configured to calculate a value for each player according to a difference between the player's prediction and the actual outcome, and
said computing device is configured to perform a statistical analysis of all said values relating to the outcome.

18. A system according to claim 16, wherein said computing device is configured to determine the relative accuracy of all players' predictions.

19. A system according to claim 17, wherein said computing device is configured to calculate a distribution of said differences for all players.

20. A system according to claim 19, wherein said computing device is configured to use a statistic related to said distribution to calculate said value.

21. A system according to claim 17, wherein the statistical analysis is performed on a distribution of all said values.

22. A system according to claim 17, wherein the statistical analysis includes computing a median of the values.

23. A system according to claim 16, wherein said computing device is configured to
tabulate entry fees received from the players; and
specify payouts to be awarded to the players in accordance with said ranking.

24. A computer-readable storage medium having stored therein instructions for performing a method, the method comprising:
constructing a prediction game in accordance with a host selecting an outcome relative to which a prediction may be made;
receiving predictions regarding said outcome from a plurality of players;
measuring the accuracy of each player's prediction compared with the actual outcome;
computing a score for each player in accordance with said measuring; and
ranking the players in accordance with the respective scores.

25. A computer-readable storage medium according to claim 24, wherein in said method
said measuring comprises calculating a value for each player according to a difference between the player's prediction and the actual outcome, and
said computing comprises performing a statistical analysis of all said values relating to the outcome.

26. A computer-readable storage medium according to claim 25, wherein in said method computing the score for a player further comprises determining the relative accuracy of all players' predictions.

27. A computer-readable storage medium according to claim 25, further comprising calculating a distribution of said differences for all players.

28. A computer-readable storage medium according to claim 27, further comprising using a statistic related to said distribution to calculate said value.

29. A computer-readable storage medium according to claim 25, wherein the statistical analysis is performed on a distribution of all said values.

30. A computer-readable storage medium according to claim 24, wherein said method further comprises:
tabulating an entry fee from each player;
specifying payouts to be awarded to the players in accordance with said ranking.

31. A user interface comprising:
a first section for composing a prediction game, including
a list of events,
a list of outcomes relating to each of the events,
a maximum number of points to be awarded based on a prediction of an outcome,
an entry fee for each player, and
a schedule for making payouts to players; and
a second section for viewing the prediction game while under construction.

32. A user interface according to claim 31, further comprising a status viewing area for viewing the status of the game while under construction.

33. A user interface according to claim 32, further comprising an area for displaying a message indicating that the game has been launched.

34. A user interface according to claim 31, further comprising an area for sending messages to persons in a social network regarding the prediction game.
